(19) United States
(12) Patent Application Publication
(10) Pub. No.: US 2013/0094191 A1
(43) Pub. Date: Apr. 18, 2013

(54) SOLAR-POWERED HANGING PLANT ILLUMINATOR

(71) Applicant: Richard Cohen, Ann Arbor, MI (US)

(72) Inventor: Richard Cohen, Ann Arbor, MI (US)

(21) Appl. No.: 13/654,019

(22) Filed: Oct. 17, 2012

Related U.S. Application Data
(60) Provisional application No. 61/548,029, filed on Oct. 17, 2011.

(51) Int. Cl. F21V 33/00

(52) U.S. Cl. 362/122

(57) ABSTRACT

A solar-powered illuminator for hanging plants or other articles includes a housing having an upper surface, a lower surface, and an interior. One or more solar panel are disposed on the upper surface of the housing, and one or more light emitters configured to provide downward illumination from the lower surface of the housing. An upper connector is disposed at or above the upper surface of the housing, and a lower connector is disposed at or below the lower surface of the housing. A central member, oriented vertically through the housing, has an upper end coupled to the upper connector and a lower end coupled to the lower connector such that, when the housing is suspended using the upper connector and a load in the form of a hanging plant is suspended from the lower connector, the weight of the load carried by the central member instead of the housing.

### REFERENCE TO RELATED APPLICATION

This application claims priority from U.S. Provisional Patent Application Ser. No. 61/548,029, filed Oct. 17, 2011, the entire content of which is incorporated herein by reference.

### FIELD OF THE INVENTION

This invention relates generally to plant hangers and. In particular, to a solar-powered hanging plant illuminator.

### BACKGROUND OF THE INVENTION

There are solar-powered illuminators for hanging plants, but the structures involved may place excessive weight on the control module, leading to premature breakage or failure. One example is disclosed in U.S. Publication No. 2007/0007275. In this device, illustrated in FIG. 5, the combination of a shade 60 and pot 62 are provided as a plant holder assembly. A plurality of support elements 66 interconnect the perimeter of the pot 62 with the perimeter of a shade element 64. In the illustrated embodiment, the lights 70 are upwardly directed, but may be alternatively or additionally outwardly directed or downwardly directed. The lights 70 may be powered by an energy storage device, such as a battery, or from a transformer or AC power. In the illustrated embodiment, a solar cell 72 is provided on the upper surface of the shade element 64 for recharging a storage element. This allows the device to act as a solar light. Preferably, during daylight hours the solar cell 72 charges the storage device. When it becomes dark, the lights 70 come on and use power from the storage device.

The problems with the structure just described are two-fold. First, the combination of a shade and a pot restricts the user to buying only that configuration shown when, in fact, a purchaser may want to use an existing pot. The combination of a shade and a pot also leads to a larger, heavier product that raises shipping costs. A second problem with this prior-art design is that some pots get very heavy, particularly when soaked with water. As such, if the components illustrated in FIG. 7 were made of plastic, for example, breakage is highly likely.

### SUMMARY OF THE INVENTION

A solar-powered illuminator for hanging plants or other articles includes a housing having an upper surface, a lower surface, and an interior. One or more solar panel are disposed on the upper surface of the housing, and one or more light emitters configured to provide downward illumination from the lower surface of the housing. One or more rechargeable batteries and electronic control circuitry are disposed within the housing to charge the batteries using energy from the solar panel(s) and to activate the light emitters using energy from the batteries. An upper connector is disposed at or above the upper surface of the housing, and a lower connector is disposed at or below the lower surface of the housing.

A central member, oriented vertically through the housing, has an upper end coupled to the upper connector and a lower end coupled to the lower connector whereby. As such, when the housing is suspended using the upper connector and a load in the form of a hanging plant is suspended from the lower connector, the weight of the load carried by the central member as opposed to the housing. In the preferred embodiment, the light emitters are LEDs. The system may further include an ambient light sensor, with the electronic control circuitry being operative to activate the light emitters at dusk.

### BRIEF DESCRIPTION OF THE DRAWINGS

FIG. 1 is an oblique view of the preferred embodiment;

FIG. 2 is a top, oblique view of the apparatus;

FIG. 3 is a bottom view;

FIG. 4 is a side view of the invention illustrating important internal components; and

FIG. 5 is a drawing of a prior-art device.

### DETAILED DESCRIPTION OF THE INVENTION

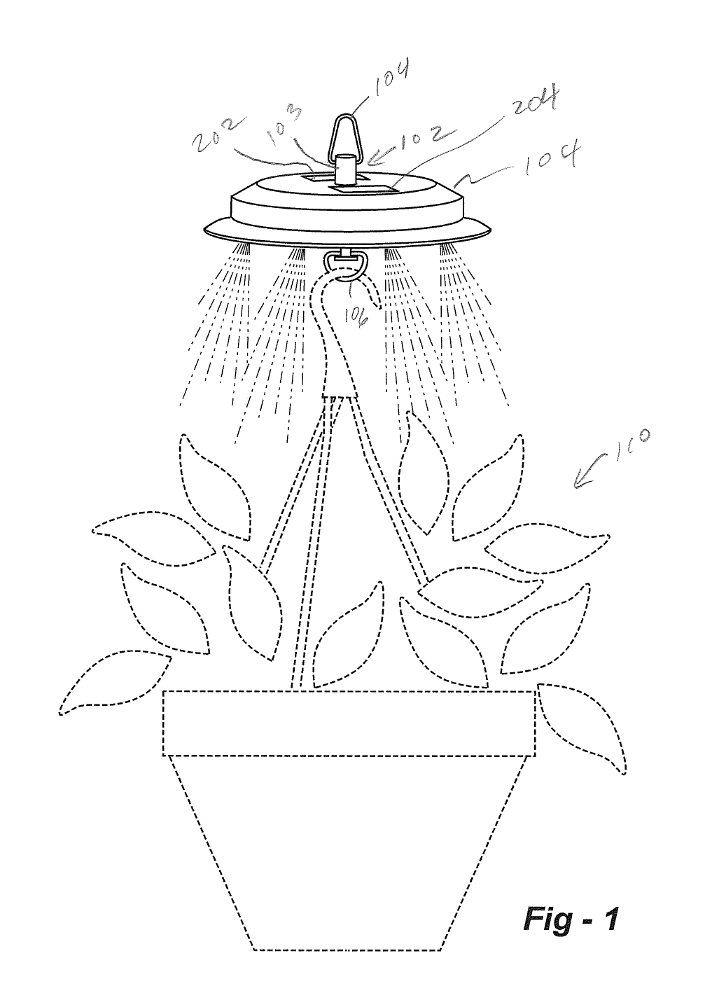

This invention improves upon the art of solar-powered illuminators for hanging plants by providing a central hanging structure 102 that places no stress on the illuminator module 104, as shown in FIG. 1. In particular, a central, vertical member 103 extends entirely through the module 104, such that no stress is placed on the module itself. The member 103 is coupled to upper and lower connectors. The upper connector 104 enables the illuminator to be hung from a hook or other device, and a hanging planter 110 may then be attached to the lower connector 106, as shown in FIG. 1. Although the connectors are depicted as eyelets or rings, hooks or other types of connectors may alternatively be used.

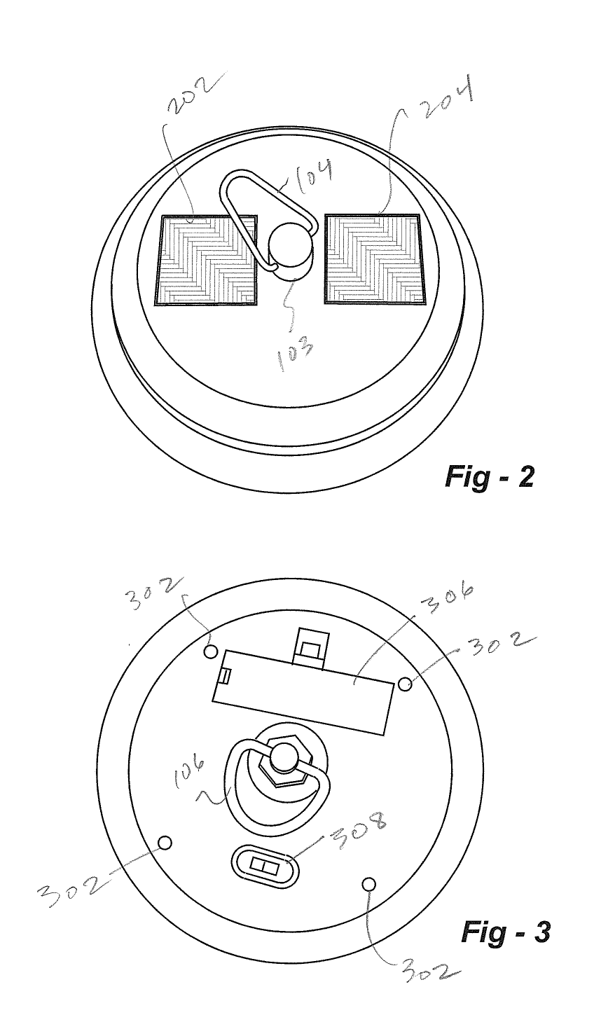

FIG. 2 is a top, oblique view of the apparatus showing solar panels 202, 204. Although two such panels are used in the preferred embodiment, more or fewer may be used. FIG. 3 is a bottom view illustrating light-emitting diodes 302. Again, although four LEDs are used in the preferred embodiment, more or fewer may be provided. The bottom view of FIG. 3 also depicts battery access panel 306 and ON/OFF switch 308.

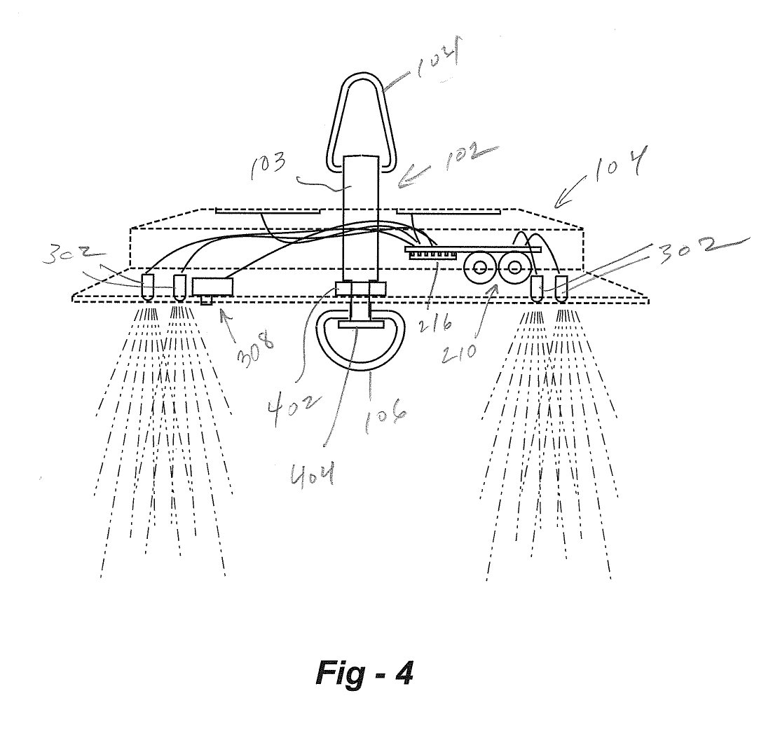

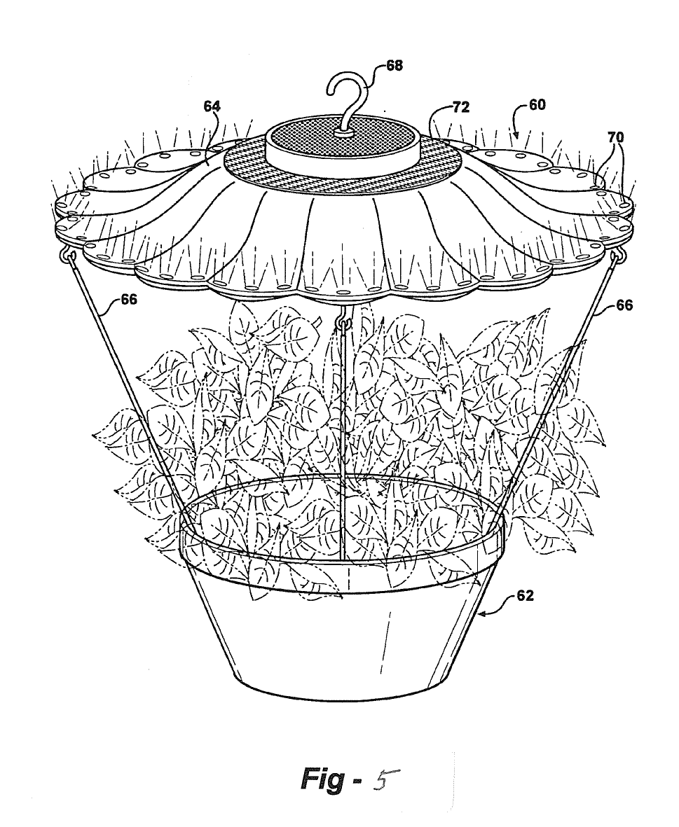

FIG. 4 is a side view of the invention illustrating important internal components. The solar panels 202, 204 charge batteries 210, with control circuitry 216 being operative to turn on LEDs 302 at dusk. A photocell (not shown) may be used for such purpose or the solar cell(s) themselves may instead be used. Appropriate circuitry is known to those of skill in the art. In the preferred embodiment, the module 104 uses a plastic housing.

Connectors 104, 106 and central member 103 may be plastic or metal. The member may be coupled to the module housing in various ways, including the use of a nut 402 received by a threaded portion (not shown). With such an arrangement, the member may be inserted from the top of the housing and held in position with the nut. The lower portion of the member may include an end structure 404 to keep connector 106 from disengaging.

I claim:

1. A solar-powered illuminator for hanging plants or other articles, comprising:
a housing having an upper surface, a lower surface, and an interior;
one or more solar panel disposed on the upper surface of the housing;
one or more light emitters configured to provide downward illumination from the lower surface of the housing;
one or more rechargeable batteries disposed within the housing;
electronic control circuitry disposed within the housing operative to charge the batteries using energy from the solar panel(s) and activate the light emitters using energy from the batteries;
an upper connector disposed at or above the upper surface of the housing;
a lower connector disposed at or below the lower surface of the housing; and
a central member oriented vertically through the housing, the member having an upper end coupled to the upper connector and a lower end coupled to the lower connector whereby, when the housing is suspended using the upper connector and a load in the form of a hanging plant is suspended from the lower connector, the weight of the load carried by the central member as opposed to the housing.

2. The solar-powered illuminator of claim 1, wherein the light emitters are LEDs.

3. The solar-powered illuminator of claim 1, further including:
an ambient light sensor; and
wherein the electronic control circuitry is operative to activate the light emitters at dusk.
